(19) United States
(12) Patent Application Publication
(10) Pub. No.: US 2026/0127693 A1
(43) Pub. Date: May 7, 2026

(54) Incentivized Youth Education System

(71) Applicant: CONSUMERON, LLC, Los Angeles, CA (US)

(72) Inventor: Mark B. BARRON, Bel Air, CA (US)

(73) Assignee: CONSUMERON, LLC, Los Angeles, CA (US)

(21) Appl. No.: 19/440,604

(22) Filed: Jan. 5, 2026

Related U.S. Application Data
(63) Continuation-in-part of application No. 19/030,545, filed on Jan. 17, 2025, now abandoned.
(60) Provisional application No. 63/622,173, filed on Jan. 18, 2024.

(51) Int. Cl. G06Q 50/20

(52) U.S. Cl. CPC G06Q 50/205

(57) ABSTRACT

An incentivizing program has youth participants enrolling into a multi-stage, incentive-based program designed to encourage prosocial choices and avoidance of serious legal trouble. Each enrolled youth is issued a secure, restricted use, handheld program device configured to present interactive missions covering a wide range of life-lesson content. Progression through age- or stage-based missions is tracked and logged on a per-participant basis, with completion events and compliance with program requirements triggering deposits into a restricted-use success account or trust. In certain embodiments, the handheld program device collects multi-modal signals indicative of a participant's state during missions and communicates summarized results to a resilience scoring service that computes a resilience score in view of contextual risk indicators. An incentive-account management engine adjusts contributions to the success account as a function of the resilience score and program policies, thereby linking in-program performance and permitted-use funds supporting life pursuits outside of criminal activity.

### CROSS-REFERENCE TO RELATED APPLICATIONS

The present application is a continuation-in-part of U.S. patent application Ser. No. 19/030,545 entitled “Incentivized Youth Education System”, filed Jan. 17, 2025, pending, which claims priority to U.S. Provisional Patent Application No. 63/622,173 , filed Jan. 18, 2024.

### FIELD OF THE INVENTION

The present invention pertains to the field of education and, more specifically, to implementing a system for the behavioral shaping of youths, particularly underprivileged youths, through a series of fact based life lessons or missions. If successfully completed by a youth at various stages of life while the youth avoids any serious legal trouble, the youth is entitled to receive a success fund for further education or other specified life pursuit purposes.

### BACKGROUND OF THE INVENTION

It is well recognized that individuals who grow up in underprivileged circumstances, whether in low income inner cities or poor rural areas, experience hardships and live under conditions which are simply not found or perhaps even fathomable by those who grow up in more prosperous regions. Many times, the hardships and conditions lead to temptations resulting in youths engaging in illegal activities which actually compounds the problem by further limiting possible future life opportunities. Many such illegal activities can result in prison time and a prison record. The experiences of prison and the resulting record can haunt individuals for the rest of their lives.

Not only is any given incarceration a liability for the individual, but to society as a whole. Although the exact number is not known, it is seemingly accepted that the cost of corrections in the United States is over $80 billion a year. However, this amount truly underestimates the real cost as it does not take into account related costs, such as social costs to affected family members and communities. Without a doubt, a system which incentivizes underprivileged youths through education to remain on the right side of the law, enabling them to stay out of prison and become proud contributors to society, would provide benefits to not only the youths themselves, but their families, communities and society in general.

### SUMMARY OF THE INVENTION

The present invention is concerned with providing a system which enables underprivileged youths to obtain important and pinpointed education geared toward real life lessons and leading the youths to avoid legal troubles while growing up. At the same time, the system is designed to incentivize the youths on this path throughout their young years, resulting in the youths earning predetermined success funds which can be used to further the lives of the youths while also benefitting society as a whole.

In accordance with certain embodiments of the invention, the system is designed to supplement the education accorded youths through the public school system and includes a series of age specific life education lessons for accepted individuals. Initially, a parent or legal guardian of an individual would need to apply to the program. To qualify, the individual must be of a beginning age group, such as between 5-10 years of age. In addition, eligibility requirements need to be met to appropriately ensure that the youth is considered as underprivileged, such as children of families below the poverty line, on welfare, or the like. Once accepted, the youth will be issued a dedicated computing device, such as a tablet or gaming console, with the youth having sole access through fingerprint, eye scan, facial recognition or the like verification techniques and the device being individually registered and certified. Although the educational materials may be pre-loaded on the device, the device may provide for restricted access to the internet to enable the education materials to be readily obtained through an authorized web portal to be downloaded and updated, as needed.

In certain embodiments, there is a minimum of 3-5 educational courses or missions, with each course being directed to a specific age range during the life of the youth. For instance, one course could be directed to children 5-10 years of age; another course could be directed to youths 11-16 years of age; and a further course could be directed to individuals between the ages of 17-21 years. Each course is therefore geared to the age of the youth and specifically designed to instill a life lesson based on facts, with each lesson intending to instill a meaningful impression on the youth, helping to lead the individual down a growth path of a valuable citizen. While taking the course, eye recognition or other verification techniques will assure that the individual assigned to the particular device is, in fact, taking the course, with time and date information being automatically logged. Upon completing each course while remaining free of any serious legal entanglements, the individual will be issued a certificate of completion, along with a monetary credit in trust for future use once the entire program has been completed and the individual reaches legal age without ever being involved in any serious illegal activities. The trust fund will have stipulations on its use, such as limiting use to further education, job training, residential expenses, food and/or retirement investing.

Overall, a system is provided that enrolls youth participants into a multi-stage, incentive-based program designed to encourage prosocial choices and avoidance of serious legal trouble over time. In accordance with a particularly preferred form of the invention, each youth is issued a dedicated handheld program device configured to present an interactive dashboard for missions, videos, scenarios and quizzes related to life-lesson content, with the device restricted to program-approved use and secured by biometric or other identity verification. Progression through age- or stage-based missions is tracked and logged on a per-participant basis, with completion events and compliance with program requirements triggering deposits into a restricted-use success account or trust. In certain embodiments, the handheld program device further collects multi-modal signals indicative of participant state during missions and communicates summarized results to a resilience scoring service that computes a resilience score in view of contextual risk indicators. An incentive-account management engine adjusts contributions to the success account as a function of the resilience score and program policies, thereby linking in-program mission performance and long-term, permitted-use funds intended to support life pursuits outside of criminal activity.

Additional objects, features and advantages of the invention will become more readily apparent from the following detailed description of preferred embodiments which are not intended to be limiting but rather exemplary for the understanding of the overall invention.

### BRIEF DESCRIPTION OF THE DRAWING

FIG. 1 is a flow diagram indicating various stages of an incentivizes youth educational system in accordance with the invention.

FIG. 2 depicts an exemplary handheld device in the form of a game pad for use in connection with the system.

### DETAILED DESCRIPTION OF THE INVENTION

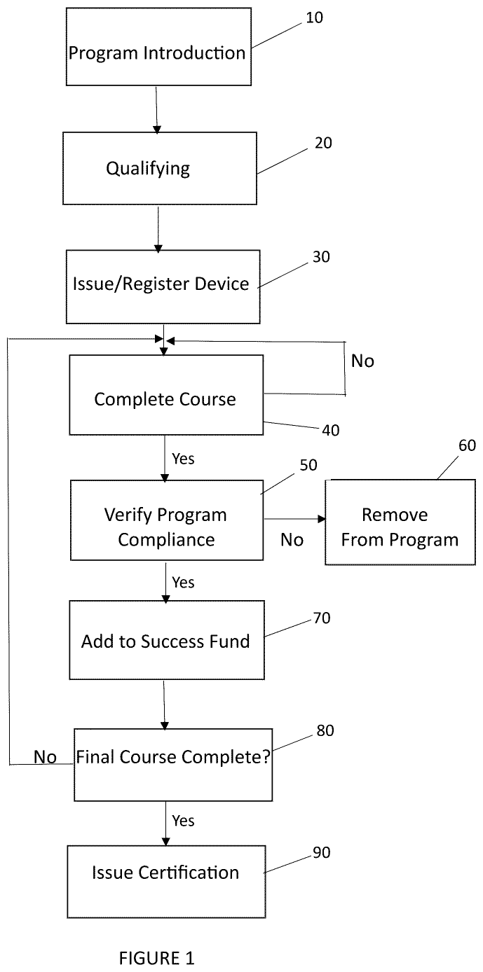

The educational system of the invention is designed to further enhance the education given to youths through the public school system and is particularly directed to provide education to underprivileged youths which are faced, at a very young age, with social and economic barriers to equal opportunities in life. This educational system is intended to instill further meaning, inspiration and hope into the lives of these individuals, shaping them to become respectable members of society while avoiding potential pitfalls which could result in issues with the law and damaging their future lives in unrealized ways. Although details and nuances of the system can vary from the preferred embodiments of the invention described below, the crux of the invention will be described in detail with reference to the representative flowchart of FIG. 1.

As seen from FIG. 1, the first step 10 in this process is simply being introduced to the program. Certainly, this can be done in a myriad of ways, including government programs, infomercials, brochures, public school referrals, simple word of mouth or the like. Once interested in the program, signing up a particular individual requires satisfying various qualifications as represented in step 20. To quality, the individual should be of a beginning age group or stage, such as between 5-10 years of age. In addition, eligibility requirements need to be met to appropriately ensure that the youth is considered as underprivileged, such as children of families below the poverty line, on welfare, or the like. In addition, the youth can have no significant juvenile record.

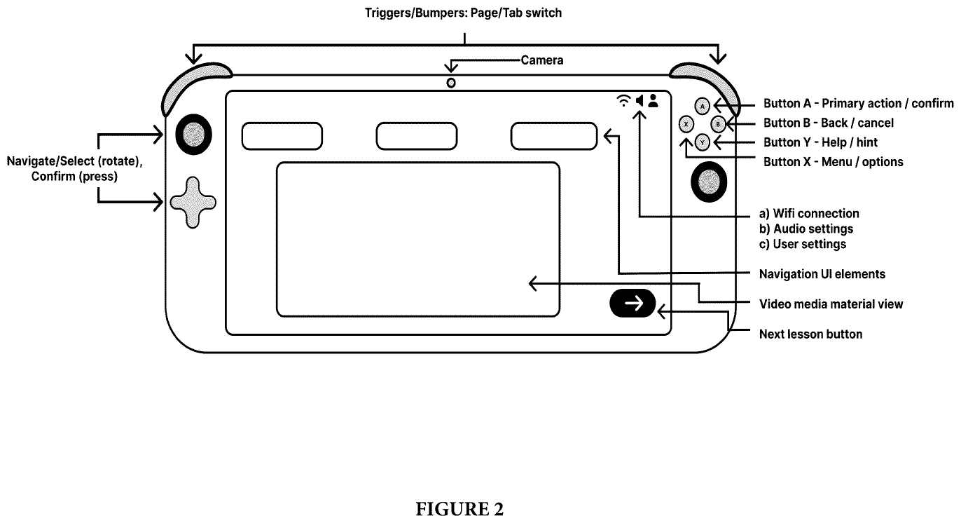

Assuming the youth meets the requisite qualifications, the individual is issued a computing device, at no cost to the individual/family, in step 30, such as an IPAD, ANDROID tablet, FIRE tablet or the like. In a particularly preferred embodiment, the device is constituted by a handheld game pad, such as that indicated in FIG. 2, having a dashboard or media viewing display, multiple control knobs, various touch selection/navigation elements, section or action button(s), a navigational pad, trigger switches, a camera and various informational display icon regions, as well as one or more microphones, and one or more biometric and/or other environmental sensors (not shown) as will be further addressed below. Although the device can be internet ready, it is preferred that the device be dedicated for use with this educational program so as to not be capable of general internet access (although at least internet-based system update availability or a dedicated link would be desirable). In addition, the computing device is specifically designed and registered for use by the particular youth to which it is assigned. To this end, issuing the device includes establishing sole access capabilities through fingerprint, eye scan, facial recognition, code, voice or the like verification techniques for the individual through the use of a fingerprint scanner, camera, microphone and/or the like built into the device. This verification is not only used to verify that nobody else is using the computing device or attending the educational sessions, but the particular individual is actually present and attentive for each given course, with added day, time and even location of use data being automatically and periodically logged. In this way, it can be effectively verified that the youth issued the particular device properly attended a given course and attendance can be verified. In addition, the device is of no use to another as it cannot be transferred or altered if lost or stolen and, upon reporting any such incident, the youth can be issued a new unit.

As indicated above, the number and type of course can vary in accordance with the invention. By way of one particular example, there can be three courses, with each course being designed for a particular age group. For instance, the age groups could be classified with stage 1 being 5-10 year olds, stage 2 covering 11-16 year olds and stage 3 being 17-21 year olds. Regardless of the exact age classifications or number of stages, each available educational course is designed based on the age group. Using this exemplary age classification and the scenario of three courses, the first course is preferably geared to make the young individual think about the right thing to do under a particular set of circumstances in order to instill high morals. For example, the course could cover a scenario concerned with finding a purse or other object owned by someone else, why it is important to try and return it, and the resulting feeling of accomplishment and self-worth. The course could also cover topics of not taking something belonging to another, avoiding being disruptive in a school classroom, and respecting authority figures, including the police, teachers, and the like. Animations, music, interactive screens and the like are desirably used to engage the child. That is, at least at this early stage, it is considered that the more entertaining the curriculum, i.e., the program is more like a game than a lecture, the more attentive and focused the child will be.

In this scenario, the second course is more directed to middle and junior high school aged individuals. These individuals are considered to be a particularly vulnerable age group, encountering life decisions that could potentially negatively affect their entire futures. This course is slated to encompass at least bullying/intimidation, gangs, drugs, the prison system and perhaps even U.S. military recruitment. Here the course would again provoke thinking on a given topic and hopefully some personal perspective consideration. The second course is earmarked to be quite fact based, such as giving statistics on annual overdoses in America and data on effects of and death tolls attributable to the use of particular drugs, as well as in-depth analysis of the U.S. prison system including stats on percentages of inmates by race, typical life in prison, state versus federal prisons and the like. In general, this course is directed to making the right life choices in crucial youth years of life.

The third course can cover various topics, including job opportunities and annual incomes for people coming out of prison versus those who never go to prison, data on repeat offenders, and information on the operation and life in cartels. In addition, information on career opportunities and aptitude, higher education degrees with anticipated salaries, and careers in sports. Information can be given on investing, data on and tips from self-made millionaires, long term benefits of relationships and family, and the like. Basically, this third course is geared toward long term planning for the future, with a life outside of crime.

Referring back to FIG. 1, when the youth is proceeding through a given course, each time there is a login the program app knows if the course has been completed, i.e., the progress of the particular individual in the specified course. Once all the materials for a given course have been reviewed and the individual confirms course completion (step 40), the app moves to step 50 wherein there is a verification of program compliance. Verification step 50 is preferably quite comprehensive. For instance, at this point, it is to be verified that the youth has not gotten into any criminal mischief which would warrant removal from the program at step 60. If being removed, the individual, as well as the parent(s) or legal guardian(s) of the youth, would be notified and an opportunity for reconsideration would exist. However, the situation should actually be quite clear from school and juvenile records. With this in mind, it is desired to have school and law enforcement/legal personnel involved in this assessment. However, if the youth had remained out of trouble such that program compliance was verified in step 50, the process proceeds to step 70 wherein a monetary deposit would be made in a predetermined amount for the youth, i.e., a success fund. The funds could be placed in a revocable trust or other interest bearing account. In any case, the sources of these funds and the potential dispersion thereof will be detailed more fully below.

Next the process proceeds to step 80 wherein it is determined if all courses for the overall program have been completed. If not and the designated individual qualifies to move up a stage, the next course in the que is presented back at step 40. If the answer is yes, then the last contribution to the success fund will have already been deposited in the prior step 70 after a final verification step 50 is performed and the process proceeds to step 90. In step 90, an official certificate of completion is issued. At this point, the individual can return the computing device and will be entitled to ownership of the funds in accordance with the provisions of the program and trust. For instance, the trust can require the funds be only used for certain things, such as further education, job training, residential expenses, food and/or retirement investing. However, the possibility could also exist to enable the funds to be transferred to other relatives, friends or the like in need. In any case, the individual would have made it through the entire program and matured beyond an age likely to be newly induced into criminal activity.

The overall program would preferably be run and overseen by an agency or bureau established for this purpose. Still, the program could certainly benefit from input from a wide range of sources. For instance, the parents of the youths could have particular insights into local concerns and happenings, even problematic changes in various sectors, like drug use, crime or other important educational worthy issues. Based thereon, a website, social media or other communication avenue could be established that would enable parents and others to comment on the content of select educational material. Various other affected parties, like law enforcement personnel, can also provide comments and suggestions, relay relevant incidents in specific demographic areas, zip codes, etc., to the agency. Given the educational materials covered on crime and jail, input may be beneficially received from incarcerated or paroled individuals, who themselves could potentially benefit from the societal contribution being made. Public and/or private school members can provide important information on various topics, such as about any successful programs enacted on related topics like respect for teachers and bullying. Various levels of the government may have informed input on the education media material/topics. With the input in mind, the education materials can be tailored as appropriate, even to specific regions in which given youths live.

Based on the above, it should be clear that input to enhance the overall program can come from various sources and in different ways. In addition to a website, input or just overall communication can go through various social media platforms. Support can be given through ad pop-ups for companies or the like which may be sponsors of the program. This valued communication can also flow in the opposite direction, with the bureau or agency providing a platform to convey statistical or other information to the parents and youths of the program, as well as to relevant communities in general. Certainly, AI could be effectively used in broadening the effectiveness of the communication.

Presumably there exist a host of philanthropists and companies willing to offer money to be used in funding this social/educational program. However, success of the program will undoubtably result in a reduction in the overall nationwide prison population and, correspondingly, the costs associated with running those prisons. Therefore, it is intended that the success funds can be paid from the money saved by the actual program such that, in accordance with an aspect of the invention, it is the government and society as a whole who will cover the costs. In fact, the savings may actually make it possible to provide further funding in the future to successful youths as a bonus for a clean record after, say, 3 or 5 years following full completion of the program. Furthermore, it is preferred that a database be established for the youths who successfully complete program, with the database being available to hiring companies and job recruiters.

For instance, although an actual deposit was described as being made to the success fund after each course completion, a lump sum could be deposited at the end with earned amounts showing up on the device of the user to encourage further educational progress. In addition, it may be decided that, rather than a lump payment after completion of the program, monthly payments for a specified period of time would better aid the grown individuals in along successful life paths. Periodically or at certain stages of completion, ceremonies could also be conducted, enabling youths to be commended through testimonials, published honorary bio information or the like. Furthermore, although step 60 was disclosed in connection with completely removing a person from the program, it is possible that, depending on the circumstances surrounding any trouble the youth may find him/herself in, it is possible that provisions can be made for instead reducing the banked amount.

In addition, at least in accordance with certain embodiments of the invention, the computing device issued at step 30 further comprises one or more sensors configured to obtain signals indicative of a state of the youth during program use. Such sensors can include, without limitation, a camera, microphone, accelerometer, heart-rate or other physiological sensor, as well as touch input or interaction timing logs. A local processing module on the computing device can be configured to derive, from these multi-modal signals, one or more state indicators, such as stress level, engagement, or responsiveness to particular program topics or mission segments.

The local processing module can implement an emotional or state inference engine which, using a trained model, fuses the multi-modal sensor inputs to generate a time-varying state vector for the youth. In preferred forms, only transformed or summarized state data is retained or transmitted off the device, while raw biometric or raw audio data is either not transmitted or is discarded after local processing, thereby preserving privacy of the youth participant while still allowing useful program analytics.

In further embodiments, mission content presented on the computing device is dynamically adapted in response to the state vector. For example, where a stress escalation pattern is detected during a particular scenario, the program can temporarily insert a relaxation, de-escalation, or coping-skills micro-mission before returning the youth to the primary storyline or life-lesson segment. As another example, repeated indications of low engagement can cause the device to change the pacing, format, or media style of the missions to better retain the youth's attention.

The system can also include a remote resilience scoring service in communication with a plurality of computing devices. The resilience scoring service can receive event summaries from the devices, including identifiers of completed missions, selected options within scenarios, derived state metrics, and timestamps. The resilience scoring service can combine these event summaries with stored profile information for the youth and with contextual risk indicators derived from external data sources, such as incident statistics, public reports, or news feeds that are associated with a geographic region or community of the youth. Based thereon, the resilience scoring service can compute a resilience score for the youth, which can be updated over time as the youth progresses through the program.

The resilience score can be decomposed into multiple sub-scores, such as a de-escalation sub-score reflecting choices favoring conflict reduction, a prosocial decision sub-score reflecting choices that benefit others or respect property, and a persistence sub-score reflecting willingness to complete missions under challenging circumstances. These sub-scores can be weighted according to program policy and aggregated with contextual risk indicators to yield an overall resilience measure at various stages of the youth's participation.

In addition to the success fund described above, an incentive-account management engine can be established to administer one or more restricted-use accounts for each youth. The incentive-account management engine can be configured to adjust contribution amounts, schedules, or allocation among sub-accounts as a function of the resilience score, stage of program completion, and current program rules. By way of example, when a youth demonstrates improvement in resilience in the face of rising local risk indicators, the incentive-account management engine may increase contribution rates or unlock additional program incentives; conversely, a significant decline in resilience may result in a reduced rate of accrual or temporary suspension of further incentive growth while still preserving prior earned amounts as determined by program policy.

The restricted-use accounts, which can include revocable trusts or other controlled financial instruments, can be configured to permit disbursements only for certain categories of expenditures, such as specified training programs, licensure or certification costs, residential stability expenses, or other program-approved developmental uses. The incentive-account management engine can interface with payment networks or merchant category systems to enforce such limitations. In certain embodiments, contributions can also be allocated in part to a community-level pool benefiting groups of youths within a particular region or cohort who maintain participation and avoid serious legal entanglements.

A guardian and sponsor portal can be provided to enable parents, guardians, social workers, or sponsoring organizations to review program progress, resilience scores, and incentive-account status for enrolled youths. The portal can provide configurable dashboards, consent management, and the ability to specify weighting parameters or thresholds for incentive adjustments, subject to overarching program rules. In some implementations, the portal can also expose application programming interfaces (APIs) to external case-management or justice-system platforms to allow appropriate, permissioned sharing of non-sensitive program status information.

Consistent with the earlier disclosure on communication channels, the state-based analytics and resilience scoring can also be aggregated in anonymized form to generate insights into trends at the neighborhood or community level. Such aggregated information can be used by the overseeing agency or bureau to tailor mission content, allocate resources, or adjust program parameters to respond to evolving risks, while individual-level personal and biometric data remains protected in accordance with privacy safeguards described herein.

It should be understood that these state-sensing, resilience scoring, and incentive-account management features can be implemented alongside, and in many cases using the same hardware and software infrastructure as, the courses and success funds previously described. The additional features thus provide a more granular, adaptive and context-aware mechanism for incentivizing prosocial development over time, while remaining within the broader framework of issuing dedicated devices, tracking stage-based participation, and connecting program performance to long-term, restricted-use financial benefits.

In certain embodiments, the handheld program device further provides a confidential reporting function for registered participants to act as issue spotters within their communities. Through a secured interface presented on the device, a youth can initiate a confidential report screen and enter or select information indicative of suspicious, threatening, or illegal activity, such as statements suggesting a potential act of violence at a school, indications of a growing local drug problem, or other conduct of concern. The confidential reporting interface can be presented as a distinct mode that is not visible within ordinary mission flows and can be accessed via a designated control sequence or icon.

The system can be configured such that confidential reports are packaged into a structured tip message including, for example, a narrative description entered by the youth, selectable categories of concern, optional attachments captured by the device (such as audio clips or images, where permitted by program policy), and metadata such as approximate time and general location. A routing module can transmit the structured tip message through one or more secure channels to designated recipients, which can include local law enforcement, school resource officers, social service agencies, or a program-operated triage center, in accordance with jurisdictional rules and program agreements.

To protect the youth participant, the confidential reporting function can implement one or more anonymity or pseudonymity options. In some implementations, the identity of the reporting youth is masked from downstream recipients or is made visible only to a limited set of authorized program personnel who can evaluate the tip and coordinate with authorities. The confidential report and any related identifiers can be excluded from standard guardian or sponsor dashboards, or shown only in redacted form, unless explicit consent or a legal requirement dictates otherwise. In certain embodiments, the system can also track patterns of reporting activity to detect and discourage malicious or frivolous use, such as repeated knowingly false reports, and can treat verified helpful tips as a positive factor in the participant's program record or resilience-related analytics, consistent with applicable policies and regulations.

In certain embodiments, the program further includes a mentorship component in which vetted adult mentors can register to support enrolled youths. A mentor management module can maintain mentor profiles including, for example, a photograph, brief biography, areas of focus, language preferences, and one or more geographic identifiers such as postal codes served. When a youth navigates to a mentor selection interface within the handheld program device, the device can present a set of available mentor profiles that are filtered or ranked based on proximity, availability, or program-defined matching criteria, enabling the youth to request or select one or more mentors.

The system can track interactions between mentors and youths through digital communication channels, in-person meeting logs, or in-app engagement metrics, and can associate such interactions with the program records of both the mentor and the youths served. A mentor performance scoring engine can be configured to compute one or more mentor scores as a function of factors such as (i) the number of youths actively mentored, (ii) the amount of time or number of sessions logged, and (iii) changes in program participation, resilience scores, or other outcome indicators of the associated youths over defined evaluation windows.

Based on these mentor scores, the system can administer mentor-facing incentives, which can include financial rewards, reputation badges, access to additional program resources, or eligibility for recognition in formal events. The mentor performance scoring engine can be integrated with the same incentive-account management infrastructure used for youth program accounts, or can utilize separate mentor-focused accounts or reward ledgers, as determined by program policy.

In some embodiments, the program further provides a recurring mentor recognition event. An awards scheduling component can periodically identify mentors with the highest impact according to one or more mentor scores, and designate such mentors for public or semi-public recognition. The system can support an awards ceremony format in which selected mentors are announced, their stories or testimonials are captured in audio or video form, and one or more tangible rewards are granted, such as monetary awards, program-sponsored experiences, or community service recognitions.

The awards ceremonies can be recorded and stored as media assets linked to the mentor module. Clips or edited segments from these ceremonies can be made accessible within a mentor-focused section of the handheld program device, allowing youths, guardians, and community members to view examples of high-impact mentorship. In this way, the mentor recognition features can reinforce program engagement, encourage mentor recruitment and retention, and help foster broader community buy-in for the behavior-shaping program.

In further embodiments, the system includes a dynamic content engine configured to generate or select awareness content illustrating systemic risks, exploitative patterns, or undesirable long-term consequences associated with certain behaviors or choices within a broader socio-economic context. In one implementation, this feature is referred to as a “Carnival Capitalism” module, in which youths are exposed, through carefully curated or synthesized media, to the less-visible aspects of profit-driven systems and how those systems can benefit and/or negatively impact vulnerable communities.

The dynamic content engine can obtain external data from one or more news feeds, public reports, or other information sources and can analyze such data to detect emerging or persistent issues in particular geographic regions, such as a rise in a specific type of substance use, gang-related activity, or local patterns of violence. Based on such detections, the engine can select, assemble, or algorithmically generate video segments, interactive narratives, or other media that illustrate plausible real-world trajectories and consequences associated with those issues, tailored to the affected regions.

By way of example, if the analysis indicates a growing problem with a particular drug in certain postal codes, the dynamic content engine can cause generation or selection of a video sequence that depicts the progression from initial experimentation to addiction, legal trouble, and health or safety consequences, presented at an age-appropriate level of detail. In another example, the engine can provide content illustrating aspects of a prison- or detention-focused economic system, including how recurring incarceration within a community can sustain revenue streams for certain entities without materially improving life outcomes for the affected population. Such content can incorporate comparative visuals, simplified numerical illustrations, or testimonies, and can be configured to encourage youths to question and opt out of behaviors that feed into those systems.

The dynamic content engine can associate each awareness segment with one or more contextual tags, such as issue type, target age range, and relevant geographic indicators. A targeting component can then schedule delivery of particular segments to youths whose program records indicate residence within affected regions or exposure to related risk factors. Exposure to such content can be logged within the program record of each youth and, in some implementations, can inform subsequent mission design, resilience scoring interpretation, or follow-on missions that ask the youth to reflect on or respond to the presented scenarios.

Although described to reference to preferred aspects, embodiments and features of the invention, it should be understood that various changes and/or modifications can be made without departing from the invention. In particular, it should be understood that the various features/aspects of the invention as disclosed herein can be used individually or in any combination, thereby including some or all of the features/aspects. In addition, for certain preferred embodiments associated with features described above, the system would employ multiple core sections, such as for the handheld device interface, the game and mission engine which provides for game play/scenario execution and mission or stage flow, a backend application for user profiles, progress, sessions, program state and the like, a scoring and incentive section for scoring, progression, and reward info and determinations, a personalization section to adapt material based on user data and context, and a content and media section to manage videos, lessons, missions and/or assessments. Certainly, for operational purposes, various programming, display and control arrangements could be employed in connection with the overall invention. Furthermore, it should be recognized that the invention encompasses both the method and system for accomplishing each of the features/aspects disclosed.

1. A method for incentivized youth participation in a multi-stage behavior-shaping learning program comprising:
providing a dedicated, handheld program device configured for use by a qualified youth, the handheld program device being specifically configured to present interactive mission content in stages and to restrict access to non-program functions;
verifying an identity of the youth for use of the handheld program device by at least one of fingerprint, eye scan, facial recognition, code input or voice recognition;
monitoring a progression of the youth through a first interactive mission stage on the handheld program device;
upon verifying when the youth has completed the first interactive mission stage and compliance with one or more other program requirements, causing a contribution to be made to a restricted-use program account established for the benefit of the youth; and
repeating the monitoring and contributing for at least a second interactive mission stage of the program, such that contributions to the restricted-use program account accumulate over multiple stages while the youth avoids disqualifying noncompliance entanglements.

2. The method of claim 1, further comprising evaluating the youth for qualification into the program based on at least two of: age; status as underprivileged; and absence of a significant juvenile record.

3. The method of claim 1, wherein the stages of the program correspond to at least three age or life stages, and the mission content presented at a particular stage is tailored to the particular stage.

4. The method of claim 1, wherein the first interactive mission stage is directed to instilling respect for others and their property, and the second interactive mission stage is directed to peer pressure, bullying, gangs and dangers of substance abuse.

5. The method of claim 4, further comprising repeating the monitoring and contributing for a third interactive mission stage directed to planning future life pursuits outside of criminal activity.

6. The method of claim 1, wherein the restricted-use program account comprises a trust or other financial instrument that is not made fully available to the youth until the youth reaches a predetermined age and satisfies final program completion criteria.

7. The method of claim 6, further comprising permitting disbursements from the restricted-use program account prior to the youth satisfying the final program completion, with the disbursements being limited to: job training; licensure or certification; residential expenses; food;
and long-term investing.

8. The method of claim 1, wherein the handheld program device constitutes a computing controller pre-programmed with and configured for use specifically in performing the interactive mission stages of the multi-stage behavior-shaping learning program.

9. The method of claim 1, further comprising, during presentation of one of the first and second mission stages on the handheld program device:
obtaining multi-modal sensor data from a plurality of sensors of the handheld program device, the multi-modal sensor data comprising at least one physiological signal and at least one of audio data or image data; and
generating, from the multi-modal sensor data, a state vector indicative of a state of the youth during the one of the first and second mission stages.

10. The method of claim 9, further comprising locally transforming the multi-modal sensor data into the state vector on the handheld program device and discarding at least a portion of raw biometric or raw audio data after such transformation.

11. The method of claim 9, further comprising adapting at least one subsequent mission segment based, at least in part, on the state vector and a history of mission choices of the youth.

12. The method of claim 9, further comprising transmitting, from the handheld program device to a remote scoring service, an event summary comprising an identifier of the youth, mission completion information, and at least a portion of the state vector.

13. The method of claim 12, further comprising, at the scoring service:
combining the event summary with profile data associated with the youth and with contextual risk indicators associated with a geographic region of the youth; and
computing a resilience score for the youth based at least on the event summary and the contextual risk indicators.

14. The method of claim 13, further comprising adjusting a rate, frequency, or allocation of contributions to the restricted-use program account in accordance with one or more programmable funding rules that depend at least in part on the resilience score.

15. The method of claim 1, further comprising providing, on the dedicated handheld program device, a confidential reporting interface configured to allow the youth to submit a report regarding suspicious, threatening, or illegal activity observed by the youth.

16. The method of claim 15, further comprising:
forming, in response to input received via the confidential reporting interface, a structured tip message including at least one of a narrative description, a selected category of concern, and time or location metadata; and
transmitting the structured tip message to at least one designated authority or program triage center via a secure communication channel.

17. The method of claim 15, further comprising controlling access to identity information associated with the youth such that the structured tip message is delivered to the designated authority in anonymized or pseudonymized form, while preserving the ability of authorized program personnel to associate the structured tip message with a corresponding program record for internal evaluation.

18. The method of claim 15, further comprising treating verified, non-frivolous confidential reports as a positive factor in analytics associated with the youth's participation in the behavior-shaping program, and treating repeated knowingly false reports as a negative factor, in each case in accordance with program policy.

19. A method for incentivized youth participation in a multi-stage behavior-shaping learning program comprising:
enrolling a qualified youth into the program based at least on age criteria and an assessment of community risk factors, and issuing to the youth a dedicated handheld program device configured to execute only program-approved applications and content;
verifying identity of the youth for use of the handheld program device by at least one of fingerprint, facial recognition, code input or voice recognition;
presenting, on the handheld program device, a sequence of behavior-shaping missions associated with multiple stages of the program, the missions being configured to model decisions relating to conflict, property, peer pressure, or exposure to criminal activity;
obtaining, during presentation of at least some of the missions, multi-modal sensor data from a plurality of sensors of the handheld program device, the multi-modal sensor data comprising at least one physiological signal and at least one of audio or image data;
deriving, by a local processing module of the handheld program device, a time-varying state vector from the multi-modal sensor data, and discarding at least a portion of raw biometric or raw audio data after derivation of the state vector so that such raw data is not transmitted off the handheld program device;
forming, on the handheld program device, an event summary comprising an identifier of the youth, mission progression information, selected mission options, and at least a compressed representation of the state vector, and transmitting the event summary to a remote resilience scoring service;
at the resilience scoring service, combining the event summary with (i) stored profile data associated with the youth and (ii) contextual risk indicators derived from external data feeds associated with a geographic region of the youth, and computing a resilience score for the youth based at least on the event summary and the contextual risk indicators;
maintaining, by an incentive-account management engine, a restricted-use program account associated with the youth, the restricted-use program account being limited to expenditures within one or more program-approved categories; and
adjusting contributions to the restricted-use program account in accordance with one or more programmable funding rules that depend jointly on the resilience score and at least one of the contextual risk indicators, such that contributions are increased when the resilience score improves in the presence of elevated contextual risk and are reduced or suspended when the resilience score declines below a threshold or the youth incurs a disqualifying legal entanglement.

20. A system for administering a multi-stage incentivized youth program, comprising:
a handheld program device configured for use by a qualified youth and being specifically configured to present interactive mission content in stages and to restrict access to non-program functions, the handheld program device comprising:
a display and input interface configured to present interactive missions and receive user input;
at least one identity verification component configured to authenticate the youth;
a plurality of sensors including at least one physiological sensor and at least one
of a microphone or camera; and
a local processing module configured to derive a state vector from signals
obtained from the plurality of sensors;
a monitoring unit configured to follow a progression of the youth through missions presented utilizing the handheld program device;
a resilience scoring service in communication with the handheld program device and configured to receive event summaries including mission progression information and at least a portion of the state vector, and to compute a resilience score for the youth; and
an incentive-account management engine configured to maintain a restricted-use program account for the youth and to adjust contributions to the restricted-use program account as a function of the resilience score and program policy.

21. The system of claim 20, wherein the local processing module is configured to discard at least a portion of raw biometric or audio data after deriving the state vector, such that only transformed data or summaries are transmitted off the handheld program device.
